(19) United States
(12) Patent Application Publication
(10) Pub. No.: US 2020/0053974 A1
(43) Pub. Date: Feb. 20, 2020

(54) MILKING DEVICE FOR MILKING DAIRY ANIMALS WITH RINSING FUNCTION

(71) Applicant: DELAVAL HOLDING AB, Tumba (SE)

(72) Inventor: Martin WIEDEMANN, Tumba (SE)

(21) Appl. No.: 16/486,644

(22) PCT Filed: Feb. 15, 2018
(86) PCT No.: PCT/SE2018/050148

§ 371 Date: Aug. 16, 2019

(30) Foreign Application Priority Data
Feb. 17, 2017 (DE) 20 2017 000 895.5

(51) Int. Cl. A01J 7/04; A01K 1/12

(52) U.S. Cl. CPC A01J 7/04; A01K 1/12

(57) ABSTRACT

A milking system for milking dairy animals with a preparation station that automatically prepares at least one teat of a dairy animal before applying milking equipment, and a milking station in which one of the animals is milked at a time, the preparation station configured to receive at least one animal to be milked, the milking system has at least one teat cup that receives a teat of the dairy animal to be milked, and the preparation station has a dispensing means that applies a pretreatment solution onto the at least one teat of the animal when it passes through the preparation station, the teat cup having a rinsing function by which the received teat is cleaned prior to the milking process, and the rinsing function removes the pretreatment solution applied onto the teat at the preparation station from the teat in a rinsing process.

### TECHNICAL FIELD

The present invention relates to a milking system configured to milk dairy animals, the milking system comprising:
at least one preparation station for automatically preparing at least one teat of a dairy animal before applying milking equipment, and
at least one milking station in which one of the animals is milked at a time, wherein the preparation station is designed to receive at least one animal to be milked,

wherein the milking system has at least one teat cup designed to receive a teat of the dairy animal to be milked, wherein the preparation station has a dispensing means arranged to apply a pretreatment solution onto the at least one teat of the animal to be milked when it passes through the preparation station.

### BACKGROUND

Such milking systems are known in the art. As an example, the document WO 2008/140407 A1 discloses such a milking system, in which a teat preparation station is provided. One purpose of this teat preparation station is to apply a cleaning substance onto a teat of the animal to be milked to prepare and disinfect it for subsequent milking. Moreover, according to said document, it may also be intended to remove, e.g. rinse off, the cleaning substance from the teat at the teat preparation station.

This solution has proven to already achieve a good cleaning of the teats. However, the application and removal of the cleaning substance at the teat preparation station is associated with a certain engineering effort leading to increased costs of the preparation station. In addition, this state of the art may require keeping the animal to be milked at the teat preparation station for a certain amount of time to ensure a sufficiently long time span for cleaning the teats, i.e. for sufficient action of the cleaning substance. This may considerably delay the overall milking process of a herd, in particular if multiple animals are to be milked in succession.

### SUMMARY

In view of the above, an objective of the present invention is to provide a milking system of the aforementioned type, ensuring thorough teat cleaning and also enabling a high throughput of animals, while avoiding any unnecessary loss of time.

This objective is achieved by a milking system configured to milk dairy animals, the milking system comprising:
at least one preparation station for automatically preparing at least one teat of a dairy animal before applying milking equipment, and
at least one milking station in which one of the animals is milked at a time,

wherein the preparation station is designed to receive at least one animal to be milked, and wherein the milking system has at least one teat cup designed to receive a teat of the dairy animal to be milked.

According to the invention, the preparation station has a dispensing means arranged to apply a pretreatment solution onto the at least one teat of the animal to be milked when it passes through the preparation station.

According to the invention, the teat cup by which the received teat is cleaned prior to the milking process is designed with a rinsing function, and that the rinsing function is provided to remove the pretreatment solution applied onto the teat at the preparation station from the teat in a rinsing process.

According to the present invention, the pretreatment solution applied at the preparation station is removed from the teat by means of the teat cup and its rinsing function. Thereby, an additional cleaning step at the preparation station, as intended in the prior art, can be avoided. Instead, rinsing of the teat to remove the pretreatment solution is performed directly with the teat cup which must be applied anyway.

According to one embodiment variant of the invention, the teat cup is provided as a separate teat preparation cup for carrying out a teat rinse, preferably the teat preparation cup is provided at a cleaning station arranged between the preparation station and the milking station but of course the separate teat preparation cup may be provided at the milking station. This embodiment variant uses a cleaning station with its teat preparation cup anyway provided in the milking system to rinse the teat and to remove the pretreatment solution. There the pretreatment solution is removed during rinsing. Such milking systems with a cleaning station are known per se in the art. What is special is the combination of applying the pretreatment solution at the preparation station and using the teat preparation cup present anyway to remove the pretreatment solution and to rinse the teat in preparation of a subsequent milking process. As a result, improved teat cleaning is achieved without any additional effort and, in particular, without any delay in time.

As an alternative to a separate teat preparation cup, it may be provided that the teat cup is designed as a part of the milking station, wherein the teat cup is designed both to perform a teat rinse and to perform a pre-milking process or the actual milking process. In other words, in a first embodiment the milking station is provided with a teat preparation cup designed to perform a teat rinse and a pre-milking process and further teat cups of the milking equipment to perform the milking subsequent the teat rinse and the pre-milking process and in a second embodiment, the teat cup, used for milking later on, is also provided with a rinsing function such that, immediately prior to milking, the pretreatment solution can be removed from the teat by the rinsing function, the teat can be sufficiently rinsed and the milking process can then be performed with the teat cup already applied. The second embodiment is particularly suitable when using a milking system having teat cups in which the teat rinsing function is implemented in addition to the milking function. Such teat cups with an integrated teat rinsing function are also offered by the applicant, among others.

A further development of the invention intends for the preparation station to have a teat preparation section with an access and an exit located remotely from the access, wherein the teat preparation section is provided with lateral boundary means between the access and the exit which are arranged for predetermined lateral positioning of the animal to be milked, wherein the pretreatment solution is applied to the teat when the animal to be milked is at its predetermined lateral positioning. In this embodiment of the invention, an animal to be milked can be appropriately positioned in the teat preparation section by the lateral boundary means to apply the pretreatment solution. In particular, the teat preparation section with its lateral boundary means can be configured such that the pretreatment solution can be specifically applied onto the teats while an animal enters or passes through the teat preparation section.

A further development of this variant of the invention further intends for the dispensing means to be able to be arranged at the bottom and comprise at least one nozzle designed to spray the pretreatment solution essentially vertically upwards to the at least one teat, preferably with a volume of the pretreatment solution of 15 to 20 ml. In this respect, it may also be intended that the dispensing means is designed with two nozzles which are arranged with a distance of about two pairs of teats in the longitudinal direction of the animal.

Preferably, according to the invention, it may also be intended that the dispensing means is designed such that the pretreatment solution is able to be applied onto the at least one teat as a foam. The application of the pretreatment solution in the form of a foam allows to efficiently apply it with a sufficiently good cleaning effect. Alternatively, it may be intended according to the invention that the dispensing means is designed to apply the pretreatment solution onto the at least one teat as an aqueous solution in a diluted form, preferably with a mixing ratio of one part by volume of pretreatment solution and at least two parts by volume of water.

As already noted above, it is important that the pretreatment solution can act on the teat for a sufficient amount of time before it is rinsed off. In this respect, it may be intended that the preparation station is dimensioned such that, when the animal to be milked passes through the preparation station after application of the pretreatment solution, a sufficient amount of time for reliable disinfection passes prior to applying the teat cup with rinsing function, preferably at least 80 to 100 seconds after application of the pretreatment solution onto at least one teat of a front pair of teats and further preferably at least 50 to 60 seconds after application of the pretreatment solution onto at least one teat of a rear pair of teats.

With respect to a structural implementation, a further development of the present invention intends for the dispensing means to be coupled to at least one of the boundary means via at least one connecting strut, preferably wherein the dispensing means is designed with at least one supply channel for feeding a pretreatment solution to the dispensing means.

In addition, it may be intended according to the invention that the supply channel is associated with a pump providing a pressure high enough to spray the pretreatment solution towards the at least one teat. It should be ensured that the pressure at which the pretreatment solution is provided is high enough to reliably apply the pretreatment solution onto the teat, but not so high that the pretreatment solution is sprayed uncontrollably or too far from the preparation station.

According to the invention, it may be intended that the milking station comprises a rotary milking parlor or several milking areas arranged one after the other in a row or offset from each other.

### BRIEF DESCRIPTION OF DRAWINGS

The invention will now be described by way of examples with reference to the attached figures. Therein:

FIG. 1 shows a schematic top view of a milking system to illustrate the present invention;

FIG. 2 shows a detailed view of a preparation station according to the present invention;

FIG. 3 shows a detailed view of a dispensing means for applying a pretreatment solution; and

FIG. 4 shows a detailed view of a teat cup with rinsing function.

### DETAILED DESCRIPTION

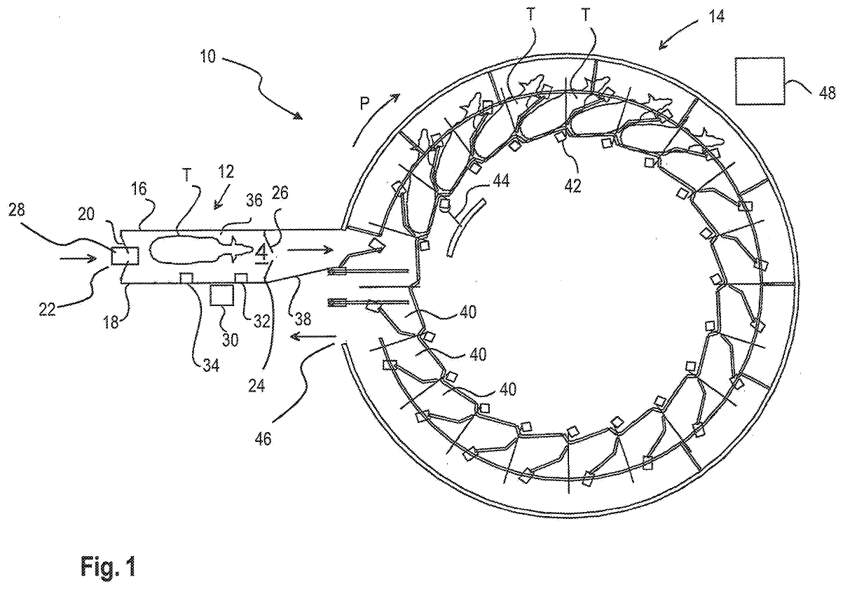

In FIG. 1, a milking system according to the present invention is schematically shown in a top view and generally denoted with 10. It comprises a preparation station 12 which is arranged in the area in front of a milking station designed as a rotary milking parlor 14.

It can be seen that lateral boundaries 16, 18 are provided at preparation station 12. Preparation station 12 is accessible through an access 22 for an animal T, which is provided with a controllable gate 20. Moreover, an exit 24 having a controllable gate 26 is provided at an end of preparation station 12. In the area of access 22, a dispensing means 28 is arranged at the bottom. Dispensing means 28 is operable to apply a pretreatment solution onto the teats from below for disinfection and cleaning of the individual teats of an animal T to be milked. For this purpose, a reservoir 30 for the pretreatment solution and a control device 32 for controlling the application of the pretreatment solution as well as a pump 34 are provided to convey the pretreatment solution to dispensing means 28 and spray it upwards therefrom.

Furthermore, an identification system for individual animals T and optionally analytical equipment may also be provided at the preparation station, which are not depicted or denoted in greater detail.

The layout of preparation station 12 with the two boundaries 16, 18 results in a passage 36 through which the animal to be milked passes. Preparation station 12 is followed by a route 38 leading the animal to be milked to rotary milking parlor 14. Rotary milking parlor 14 comprises a series of radially arranged milking stalls 40 for receiving animals T.

Each individual milking stall 40 is provided with milking equipment 42 to which the individual teat cups (not shown in FIG. 1) are attached. These can be put on the teats of a given animal T to be milked by a robotic arm 44 while the animal is at a desired target position within the respective milking stall, as shown in FIG. 1. Rotary milking parlor 14 rotates together with the animals according to the arrow P in a clockwise direction at a preset or variable speed. During rotation, the individual animals T located at the milking stalls 40 are milked. After one turn, once the milking process is complete, the animals T are released into an exit section 46 from the respective milking stall 40. A control device 48 is provided for controlling rotary milking parlor 14.

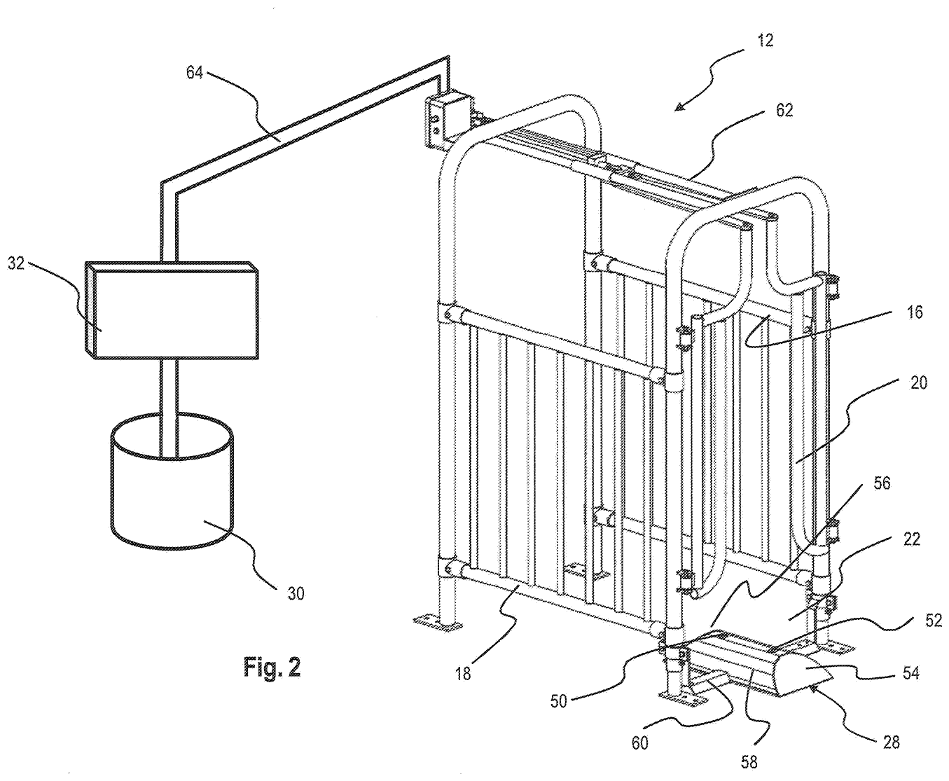

FIG. 2 shows a detailed view of a preparation station 12, as already described with respect to FIG. 1. It can be seen that dispensing means 28 for the pretreatment solution is provided in access section 22. It comprises two nozzles 50, 52 by which the pretreatment solution can be applied onto teats of an animal to be milked from below in the shape of a disc. The two nozzles 50, 52 are spaced from one another by about the usual distance of two pairs of teats of an udder. Dispensing means 28 is provided with sloping surfaces 54, 56 at the ends thereof to prevent animals from tripping, and has a profile 58 in the shape of a cylinder jacket which is resistant to trampling. It can also be seen that dispensing means 28 is connected to both barriers 16, 18 designed as a grid arrangement by a connecting strut 60. In addition, gate 20 can be seen at access 22. This gate 20 has a double-winged design and is operable by control rods 62 to selectively open it to allow an animal to enter preparation station 12, and to then close it to prevent an animal from backing out of the preparation station or the next animal from moving up prematurely at an inappropriate time.

In FIG. 2, reservoir 30 for accommodating the pretreatment solution and control system 32 and a supply line 64 for feeding the pretreatment solution from the reservoir to dispensing means 28 can also be seen.

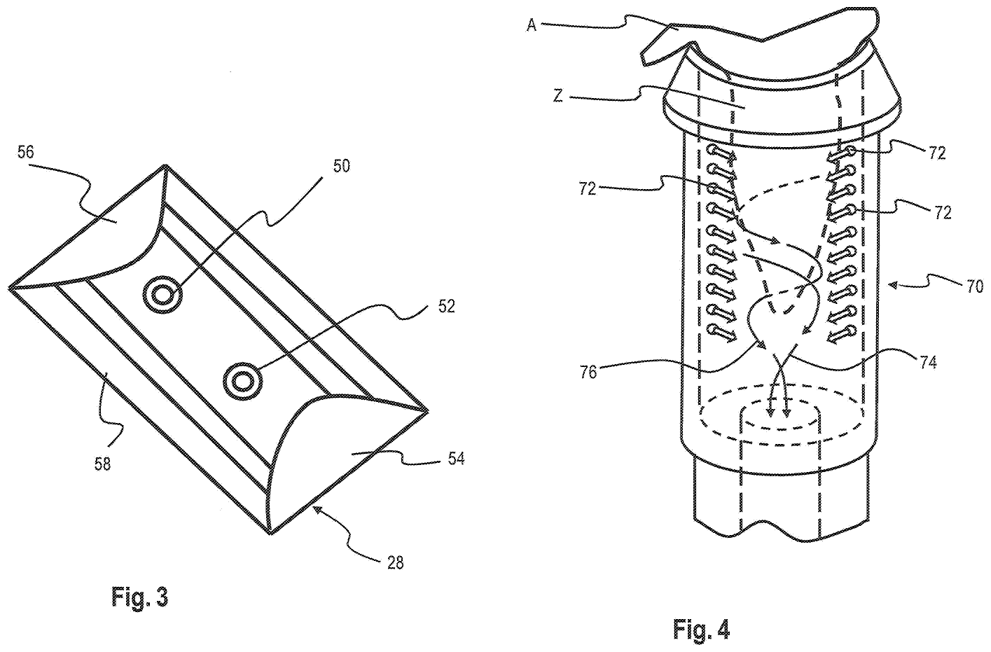

FIG. 3 shows a detailed view of the dispensing means with both nozzles 50, 52 which are of conical design, and with the sloping ends 54, 56 and the profile 58 in the shape of a cylinder jacket.

Finally, in FIG. 4, a teat cup 70 with a section A of an udder and a teat Z received in teat cup 70 can be seen. The teat cup 70 is here shown as a separate teat cup from the teat cups of the milking equipment 42 and the teat cup 70 is a separate teat preparation cup. In particular, one can also see here how a rinsing solution is introduced through provided openings 72 and the teat is thus rinsed and cleaned in accordance with the flow arrows 74, 76. As such, the pretreatment solution applied by dispensing means 28 onto the teats can be removed from the teat completely during the rinsing process in teat cup 70. On the whole, through the combination of applying the pretreatment solution, this pretreatment solution acting over a certain period of time and subsequently rinsing the teat to remove the pretreatment solution, a high udder hygiene and clean teats can be achieved to obtain a high milk quality.

The system according to the present invention is based on preparation station 12 applying a pretreatment solution onto the teats via dispensing means 28, preferably in the form of a foam or as an aqueous solution, said pretreatment solution acting for as long as the animal needs to pass through preparation station 12 and reach the assigned milking stall 40. Before the milking equipment 42 is applied to the teats by robotic arm 44 the respective teat is first rinsed with the aid of the separate teat preparation cup teat 70 that is applied to a respective teat by the robotic arm 44. As a result, teats Z are rinsed by the rinsing function of teat separation cup 70, wherein the pretreatment solution is rinsed off together with possible contaminants on the teat. It is to be noted that there might be several separate teat preparation cups. This procedure ensures a sufficiently long time of exposure to the pretreatment solution for cleaning and disinfecting the teats without having to needlessly delay guiding individual animals to milking stalls 40. In this way, times of exposure to the pretreatment solution can be achieved which lie between a few seconds and up to more than 2 minutes, wherein the time needed by the animal to pass through preparation station 12 and reach the assigned milking stall 40 is utilized for exposure to the pretreatment solution.

According to the invention, an efficient and time-saving cleaning of the individual teats is thus achieved before the milking process can be started.

It should be noted that teat cup 70 of the described embodiment of the invention may be used to merely provide the rinsing function, while separate different teat cups (not shown) may be used for the actual milking process which may be put on the teats later after removing teat cups 70. Furthermore, teat cups 70 may also be designed such that they are first used to perform the rinsing process to remove the pretreatment solution and clean the teats, and then, after the rinsing process, a pre-milking process and/or the actual milking process is performed with one and the same teat cups.

One possible pretreatment solution is, for example, the DeLaval Biofoam® product sold by the applicant, which is applied to the teats as a foam. Depending on the given application, different concentrations may be used, for example with a mixing ratio of 1:3 with 3 parts water.

1. A milking system (10) configured to milk dairy animals, the milking system (10) comprising:
a preparation station (12) for automatically preparing at least one teat (Z) of a dairy animal (T) before applying milking equipment (42); and
at least one milking station (14), located forward from the preparation station (12) along a route for leading the dairy animal from the preparation station, in which one of the dairy animals (T) is milked at a time,
wherein the preparation station (12) receives at least one dairy animal (T) to be milked,
wherein the milking system (10) has at least one teat cup (70) that receives a teat (Z) of the dairy animal (T) to be milked,
wherein the preparation station (12) includes a teat preparation section delimited by an access (22), an exit (24) located remotely from the access (22), and lateral boundary means (16, 18) extending between the access (22) and the exit (24), and also includes a dispensing means (28) that applies a pretreatment solution onto the at least one teat (Z) of the dairy animal (T) to be milked when the dairy animal passes through the preparation station (12) between the lateral boundary means (16, 18),
wherein the at least one teat cup (70) operates to carry out a rinsing function by which the received teat (Z) is cleaned prior to a milking process, and
wherein the rinsing function of the at least one teat cup (70) removes from the received teat (Z) the pretreatment solution applied at the preparation station (12) in a rinsing process.

2. The milking system (10) as claimed in claim 1, wherein the at least one teat cup (70) is provided as a teat preparation cup different from teat cups of the milking system (10) configured for milking the dairy animal (T).

3. The milking system (10) as claimed in claim 2, wherein the at least one teat preparation cup (70) is part of the milking station (14).

4. The milking system (10) as claimed in claim 2, wherein the at least one teat preparation cup is provided at a cleaning station arranged between the preparation station (12) and the milking station (14).

5. The milking system (10) as claimed in claim 1, wherein the at least one teat cup (70) is part of the milking station (14), and the at least one teat cup (70) is configured to perform both the rinsing function and the milking process.

6. The milking system (10) as claimed in claim 1,
wherein the lateral boundary means (16, 18) between the access (22) and the exit (24) are arranged for predetermined lateral positioning of the dairy animal (T) in order to position the dairy animal (T) for receiving the pretreatment solution from the dispensing means onto the at least one teat (Z) of the dairy animal (T).

7. The milking system (10) as claimed in claim 1, wherein the dispensing means (28) is positioned on a floor surface of the preparation station (12) and comprises at least one nozzle (50, 52) arranged to spray the pretreatment solution vertically upwards to the at least one teat (Z).

8. The milking system (10) as claimed in claim 1, wherein the dispensing means (28) comprises two nozzles (50, 52) distanced from one another along a longitudinal direction of the dairy animal (T).

9. The milking system (10) as claimed in claim 1, wherein the dispensing means (28) applies the pretreatment solution onto the at least one teat (Z) as a foam.

10. The milking system (10) as claimed in claim 1, wherein the dispensing means (28) applies the pretreatment solution onto the at least one teat (Z) as an aqueous solution in a diluted form.

11. The milking system (10) as claimed in claim 1, wherein the preparation station (12) is dimensioned such that, when the dairy animal (T) to be milked passes through the preparation station (12) after application of the pretreatment solution, a sufficient amount of time for reliable disinfection passes prior to applying the at least one teat cup (70) to carry out the rinsing function.

12. The milking system (10) as claimed in claim 7, wherein the dispensing means (28) is coupled to at least one of the boundary means (16, 18) via at least one connecting strut (60).

13. The milking system (10) as claimed in claim 12, wherein the supply channel (64) is in connection with a pump (34) providing a pressure to spray the pretreatment solution towards the at least one teat (Z).

14. The milking system (10) as claimed claim 1, wherein the milking station (14) comprises a rotary milking parlor with a plurality of said milking stalls.

15. The milking system as claimed in claim 7, wherein a volume of the pretreatment solution sprayed vertically upwards to the at least one teat (Z) is 15 to 20 ml.

16. The milking system as claimed in claim 10, wherein the aqueous solution of the pretreatment solution has a mixing ratio of one part volume of pretreatment solution and at least two parts volume of water.

17. The milking system as claimed in claim 1, wherein the preparation station (12) is configured such that at least 80 to 100 seconds is required, after application of the pretreatment solution onto at least one teat of a front pair of teats of the dairy animal (T), for the dairy animal (T) to pass through the preparation station (12).

18. The milking system as claimed in claim 1, wherein the preparation station (12) is configured such that at least 50 to 60 seconds is required, after application of the pretreatment solution onto at least one teat of a rear pair of teats of the dairy animal (T), for the dairy animal (T) to pass through the preparation station (12).

19. The milking system as claimed in claim 7, wherein the dispensing means (28) is coupled to at least one of the boundary means (16, 18) via at least one connecting strut (60) in which is provided at least one supply channel (64) for feeding a pretreatment solution to the dispensing means (28).

20. The milking system as claimed in claim 1, wherein the access (22) of the preparation section includes a first controllable gate (20), and the exit (24) of the preparation section includes a second controllable gate (26), the second controllable gate (26) openable to permit the dairy animal (T) to exit the preparation station (12) and proceed to the at least one milking station (14).
